(19) United States
(12) Patent Application Publication
(10) Pub. No.: US 2011/0255205 A1
(43) Pub. Date: Oct. 20, 2011

(54) PROTECTION DEVICE AGAINST ELECTRICAL DISCHARGES IN AIRCRAFT

(75) Inventors: Jose Ignacio LOPEZ-REINA TORRIJOS, Madrid (ES); Oscar Berenguer Monge, Madrid (ES)

(73) Assignee: AIRBUS OPERATIONS S.L.

(21) Appl. No.: 13/089,864

(22) Filed: Apr. 19, 2011

Related U.S. Application Data
(63) Continuation of application No. 11/794,485, filed on Oct. 20, 2009, now abandoned.

(30) Foreign Application Priority Data
Dec. 30, 2004 (ES) P 200403145

(51) Int. Cl. H05F 3/00

(52) U.S. Cl. 361/218

(57) ABSTRACT

This invention relates to a protection device against electrical discharges to an aircraft, especially against lightning, applicable to an external structural surface element (1), completely or partially built from a composite, comprising at least one metallic attachment element (7) with countersinking, a fine metallic mesh (2) for outer protection of said surface (1), a thick metallic mesh (5) in an area around the attachment elements (7); a metallic part (11) fixed to the inner face of the surfacing (1) by means of an attachment element (7); and a metallic washer (9) surrounding the countersunk area of the to attachment element (7) with which said metallic meshes (2, 5) come into contact.

### CROSS REFERENCE APPLICATIONS

This application is a continuation of U.S. patent application Ser. No. 11/794,485 filed Oct. 20, 2009 which is a 371 of PCT/ep2005/057184 filed Dec. 27, 2005, the contents of which are incorporated herein by reference.

### FIELD OF THE INVENTION

The invention relates to an arrangement of elements defining an overall protection system against electrical discharges in exposed structures of aircraft made with composites, such as carbon fiber, with low electrical conductivity.

### BACKGROUND OF THE INVENTION

Due to the low conductivity of composites, and particularly carbon fiber, the need to protect them against electrical discharges when they are used in aircraft structures, and quite particularly in fuel tanks, is well known.

The phenomena related to mitigate severe electrical discharges that must be prevented in a structure made of a composite to assure its structural integrity/resistance in the event of lightening striking/electrical discharge are mainly the following:

Hot spots: the high current density in certain specific locations of the structure, such as joints or intersection elements, may generate spots with high temperatures. If this temperature exceeds 200° C. (auto-ignition point of the fuel considered by FAA/JAA authorities), the fuel may reach its ignition point when the suitable stoichiometric concentrations are present inside the tank.

Structural damages (holes, delaminations, melting . . . ): when a structure is subjected to a strong discharge such as the one coming from lightening striking, structural damages occur which, if very severe, may cause structural failure.

Electric arcs (sparking): the flow of current through materials with different resistances and in geometrically spaced locations may cause voltage differences amongst one another, releasing discharges in the form of an electric arc and causing the ignition of the fuel/inflammable liquid contained in the structure.

The applicant company of this invention has tested several protection systems for structures integrating, in very specific configurations, various elements, such as solid or sandwich-type laminates made of composites, rivets and/or screws, internal metallic flat bars (metallic substructure), external metallizations (co-cured metallic meshes), washers and metallic sleeves.

One of them is disclosed in Spanish patent application ES 2,163,951.

### SUMMARY OF THE INVENTION

This invention proposes using additional elements in the structure to be protected that provide a suitable electrical path of current without the main structure experiencing damage caused by the current flowing.

The integral assembly of these additional elements as specified in claim 1 forms a framework of a high current carrying capability that allows current flowing and dissipation within the whole structure.

This framework includes an external metallization based on metallic meshes co-cured with the composite and a metallic plate, located inside the structure. This metallic plate has a variable section according to the material from which it is made. The attachment elements, such as rivets and screws, are provided with a washer improving their electrical connection to the external metallic meshes, providing a suitable current drainage path between them and the internal metallic plate.

With this configuration, the acting current is dispersed by the external metallic meshes and as they do not have sufficient electrical qualities to conduct the whole current, the device includes a main metallic path made up of the other mentioned elements (internal metallic network).

The protection device against electrical discharges according to this invention is very efficient in terms of maintenance, weight savings, cost reduction and easy manufacture.

Particularly in relation to the device object of Spanish patent ES 2,163,951, this invention improves overall protection thanks to the interposition elements between the attachment elements and the structure, making a current path between the external metallization and the internal metallic network possible.

Other features and advantages of this invention will be understood from the following detailed description of an illustrative embodiment of its object in relation to the attached drawings.

### BRIEF DESCRIPTION OF THE DRAWINGS

FIG. 1 shows a section of an aircraft structure with the protection device according to this invention.

### DETAILED DESCRIPTION OF THE INVENTION

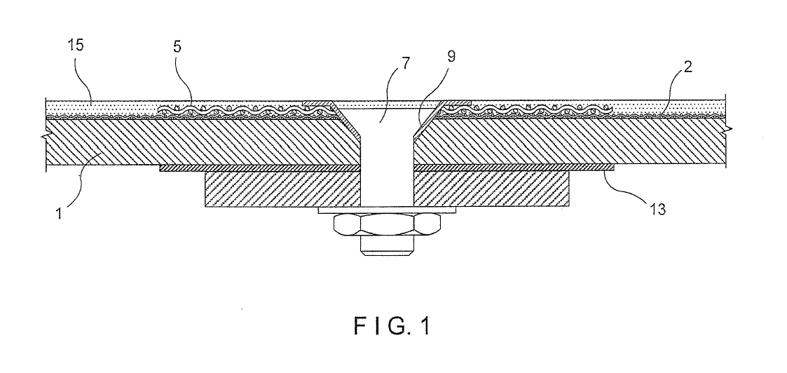

According to FIG. 1, a carbon fiber structure/surfacing 1 on an epoxy matrix is observed, on the outer face of which there is located a fine metallic mesh, in a preferred embodiment a 166×166 threads per inch bronze mesh with a wire diameter of 0.063 mm, covering the entire outer face which is applied by curing said surfacing 1 together with the mesh 2. The use of this type of meshing in protection devices against electrical discharges has been described in the prior art.

Overlapping the fine metallic mesh 2, a thick bronze mesh 5 is applied which is, in a preferred embodiment, 72×72 bronze threads per inch, with a wire diameter of 0.140 mm, in an area comprising at least 50 mm in an imaginary line of connection of attachment elements which will be discussed below. Like the previous mesh, this mesh 5 is applied by curing said surfacing 1 together with the mesh 5.

Wire diameter is the parameter that defines the different conductive capacity of fine mesh and thick mesh.

The attachment elements 7, which will preferably be rivets, are installed with the corresponding countersinking and with a metallic washer 9 interposed between the countersunk part of the attachment element 7 and the surfacing 1. The washer 9 carries out the essential function of using the entire conical surface of the countersinking to form a good electrical contact with the two outer metallic meshes 2, 5.

Arranged on the inner face of the surfacing 1 there is a metallic part 11 made of a highly conductive material (for example aluminum), responsible for draining the current coming from the outer face of the surfacing 1, conducted through the outer metallic meshes 2, 5. Although the discussed washers 9 are highly efficient in terms of assuring the electrical connection, the use of them can be optimized if an attachment element (rivet) is arranged every 200 mm.

The use of washers 9 adapted to the geometry of the rivet assure a good electrical connection between the outer metallic meshes 2, 5 and the rivet in such way that the drainage of current from the outside towards the metallic part 11, preferably formed by metallic strips of a material with high electrical conductivity, such as aluminum for example, in which case, an isolating sheet 13 must be included to prevent corrosion.

The outer metallic meshes 2, 5 are preferably made of bronze and have good maintainability and durability features supported by the tests performed, not requiring the application of any special surfacing to preserve their integrity. The entire area can be coated with an organic finish 15.

One of the most important advantages provided by this invention is the resulting aerodynamics. The installation of elements integrating the protection device according to the invention does not interfere with the outer resulting surface, the latter remaining with its minimum roughness. The overall aerodynamic efficiency increases, reducing fuel consumption. This advantage is very important in aeronautical structures such as fuel tanks located in the wing or stabilizers.

Any modifications comprised within the scope defined by the following claims can be introduced in the preferred embodiment described above.

1. A protection device against electrical discharges, especially against lightning, of an aircraft structural surface element (1), completely or partially built from a composite, comprising at least one metallic attachment element (7) with countersinking, a thin metallic mesh (2) for outer protection of said surfacing (1), characterized in that it also comprises the following elements:
a) a thick metallic mesh (5) in an area around the attachment elements (7);
b) a metallic part 11 fixed to the inner face of the surface (1) by means of an attachment element (7); and
c) a metallic washer (9) surrounding the countersunk area of the attachment element (7) with which said metallic meshes (2, 5) come into contact.

2. A device according to claim 1, characterized in that said metallic meshes (2, 5) are made of bronze.

3. A device according to claim 1, characterized in that the thick metallic mesh (5) is overlapped on the fine metallic mesh (2) in at least 50 mm along an imaginary line of connection of attachment elements.

4. A device according to claim 1, characterized in that the attachment elements (7) are titanium screws or rivets.

5. A device according to claim 1, characterized in that the metallic part (11) is made of aluminum and the device also comprises an isolating sheet (13) between it and the surface (1).
